(19) United States
(12) Patent Application Publication
(10) Pub. No.: US 2018/0021758 A1
(43) Pub. Date: Jan. 25, 2018

(54) CORE-SHELL SUPPORT, METHOD FOR PRODUCING THE SAME, CATALYST FOR PURIFICATION OF EXHAUST GAS USING THE CORE-SHELL SUPPORT, METHOD FOR PRODUCING THE SAME, AND METHOD FOR PURIFICATION OF EXHAUST GAS USING THE CATALYST FOR PURIFICATION OF EXHAUST GAS

(71) Applicant: TOYOTA JIDOSHA KABUSHIKI KAISHA, Aichi (JP)

(72) Inventors: Naoki KUMATANI, Nagakute-shi (JP); Toshitaka TANABE, Nagakute-shi (JP); Masahide MIURA, Toyota-shi (JP)

(73) Assignee: TOYOTA JIDOSHA KABUSHIKI KAISHA, Aichi (JP)

(21) Appl. No.: 15/550,148

(22) PCT Filed: Mar. 1, 2016
(86) PCT No.: PCT/JP2016/056908

§ 371 Date: Aug. 10, 2017

(30) Foreign Application Priority Data
Mar. 12, 2015 (JP) 2015-049275
Feb. 4, 2016 (JP) 2016-019455

(51) Int. Cl. B01J 23/63; B01J 37/02; B01J 21/06; B01D 53/94; B01J 35/02

(52) U.S. Cl. CPC B01J 23/63; B01D 53/94; B01J 35/02; B01J 21/066; B01J 37/0215

(57) ABSTRACT

A core-shell support, comprising:
a core which comprises at least one oxygen storage/release material selected from the group consisting of ceria-zirconia based solid solutions and alumina-doped ceria-zirconia based solid solutions; and
a shell which comprises a rare earth-zirconia based composite oxide represented by a composition formula: (Re₁₋ₓCeₓ)₂Zr₂O₇₊ₓ (where Re represents a rare earth element, and x represents a number of 0.0 to 0.8) and with which an outside of the core is coated,
the rare earth-zirconia based composite oxide comprising crystal particles having a pyrochlore structure, and
the rare earth-zirconia based composite oxide having an average crystallite diameter of 3 to 9 nm.

### TECHNICAL FIELD

The present invention relates to a core-shell support, a method for producing the core-shell support, a catalyst for purification of exhaust gas using the core-shell support, a method for producing the catalyst, and a method for purification of exhaust gas using the catalyst for purification of exhaust gas.

### BACKGROUND ART

Development of three-way catalysts, oxidation catalysts, NOx storage-reduction catalysts, and the like serving as catalyst for purification of exhaust gas mounted on automobiles and the like has been made from the past in order to remove harmful components such as harmful gases (hydrocarbons (HCs), carbon monoxide (CO), and nitrogen oxides (NOx)) contained in exhaust gas. In addition, with the recent growing environmental awareness, regulation of exhaust gas emitted from automobiles and the like has been further tightened, and accordingly improvement of these catalysts has been advanced.

As such a catalyst for purification of exhaust gas, Japanese Unexamined Patent Application Publication No. 2007-144290 (Patent Literature 1) discloses a catalyst for purification of exhaust gas comprising: noble metal particles comprising at least rhodium particles; an oxygen storage/release material particle; and a supporting oxide, such as ZrO₂ or TiO₂, which is present between the noble metal particles and the oxygen storage/release material particle and which supports the noble metal particles on a surface separated from the oxygen storage/release material particle, wherein the catalyst for purification of exhaust gas comprises a support having a core-shell structure in which the oxygen storage/release material particle forms a core portion and the supporting oxide forms a shell portion covering the oxygen storage/release material particle, and the noble metal particles are in contact with an outer surface of the supporting oxide of the support. In the catalyst for purification of exhaust gas disclosed in Patent Document 1, the supporting oxide such as ZrO₂ or TiO₂ covers the entirety of the core member made of the oxygen storage/release material (OSC material) such as CeO₂. With this structure, however, the oxygen storage/release capacity brought by the core member greatly decreases, and the oxygen storage/release capacity (OSC) is not necessarily sufficient.

Moreover, since catalysts for purification of exhaust gas have been recently required to have increasingly advanced properties, there has been a demand for a catalyst support for purification of exhaust gas and a catalyst for purification of exhaust gas which offer such a very advanced catalytic performance that both oxygen storage/release capacity (OSC) and NOx removal activity can be exhibited sufficiently.

### CITATION LIST

### Patent Literature

[PTL 1] JP2007-144290A1

### SUMMARY OF INVENTION

### Technical Problem

The present invention has been made in view of the above-described problems of the conventional technologies, and an object of the present invention is to provide a core-shell support which enables both sufficiently good oxygen storage/release capacity (OSC) and sufficiently good NOx removal activity to be exhibited, a method for producing the core-shell support, a catalyst for purification of exhaust gas using the core-shell support, a method for producing the catalyst, and a method for purification of exhaust gas using the catalyst for purification of exhaust gas.

### Solution to Problem

The present inventors have conducted intensive study to achieve the above-described object, and consequently found the following fact. Specifically, when a core-shell support comprises: a core which comprises at least one oxygen storage/release material selected from the group consisting of ceria-zirconia based solid solutions and alumina-doped ceria-zirconia based solid solutions; and a shell which comprises a rare earth-zirconia based composite oxide with a specific composition and with which an outside of the core is coated, the rare earth-zirconia based composite oxide comprises crystal particles having a pyrochlore structure, and the average crystallite diameter of the rare earth-zirconia based composite oxide is in a specific range, it is possible to obtain a core-shell support which enables both oxygen storage/release capacity (OSC) and NOx removal activity to be exhibited sufficiently, a method for producing the core-shell support, a catalyst for purification of exhaust gas using the core-shell support, a method for producing the catalyst, and a method for purification of exhaust gas using the catalyst for purification of exhaust gas. This finding has led to the completion of the present invention.

A core-shell support of the present invention comprises:

a core which comprises at least one oxygen storage/release material selected from the group consisting of ceria-zirconia based solid solutions and alumina-doped ceria-zirconia based solid solutions; and

a shell which comprises a rare earth-zirconia based composite oxide represented by a composition formula: (Re₁₋ₓCeₓ)₂Zr₂O₇₊ₓ (where Re represents a rare earth element, and x represents a number of 0.0 to 0.8) and with which an outside of the core is coated,

the rare earth-zirconia based composite oxide comprising crystal particles having a pyrochlore structure, and

the rare earth-zirconia based composite oxide having an average crystallite diameter of 3 to 9 nm.

In the core-shell support of the present invention, x in the composition formula is preferably a number of 0.5 to 0.7.

In addition, in the core-shell support of the present invention, Re in the composition formula is preferably at least one element selected from the group consisting of La, Nd, Pr, and Y.

A first catalyst for purification of exhaust gas of the present invention is a catalyst comprising: the above-described core-shell support of the present invention; and a noble metal supported on the core-shell support. In the first catalyst for purification of exhaust gas of the present invention, the noble metal is preferably Rh.

A second catalyst for purification of exhaust gas of the present invention comprises: a substrate; and a catalyst layer disposed on the substrate, wherein the catalyst layer contains the core-shell support of the present invention, alumina, and a noble metal. Also in the second catalyst for purification of exhaust gas of the present invention, the noble metal is preferably Rh.

In addition, in the second catalyst for purification of exhaust gas of the present invention, it is preferable that

(1) at least part of the noble metal be supported on the core-shell support, and/or

(2) the catalyst layer further comprise a zirconia-based support, and at least part of the noble metal be supported on the zirconia-based support.

Moreover, in the second catalyst for purification of exhaust gas of the present invention, it is preferable that the catalyst layer be a rhodium-containing catalyst layer containing Rh as the noble metal, and a palladium-containing catalyst layer containing a ceria-zirconia based solid solution and/or an alumina-doped ceria-zirconia based solid solution, alumina, and Pd be disposed between the substrate and the rhodium-containing catalyst layer.

A method for producing a core-shell support of the present invention is a method for producing the above-described core-shell support of the present invention, the method comprising:

a solution preparation step of preparing a solution containing a rare earth element salt and a zirconium salt;

a first coating step of bringing the prepared solution into contact with a powder of at least one oxygen storage/release material selected from the group consisting of ceria-zirconia based solid solutions and alumina-doped ceria-zirconia based solid solutions to obtain a core-shell powder supporting the prepared solution in an amount which gives, after calcination to an oxide, 1 to 8 parts by mass of the rare earth-zirconia based composite oxide constituting a part of the shell relative to 100 parts by mass of the oxygen storage/release material constituting the core, followed by calcination at a temperature in a range from 600 to 1100° C. and then by grinding; and

a second coating step of bringing the prepared solution into contact with the obtained core-shell powder to obtain the core-shell powder additionally supporting the prepared solution in an amount which gives, after calcination to an oxide, 1 to 8 parts by mass of the rare earth-zirconia based composite oxide constituting a part of the shell relative to 100 parts by mass of the oxygen storage/release material constituting the core, followed by calcination at a temperature in a range from 600 to 1100° C. and then by grinding,

the core-shell support being obtained by performing the second coating step until an amount of the rare earth-zirconia based composite oxide constituting the shell after the calcination to the oxide reaches 4 to 24 parts by mass relative to 100 parts by mass of the oxygen storage/release material constituting the core.

A method for producing a catalyst for purification of exhaust gas of the present invention is a method for producing the above-described first catalyst for purification of exhaust gas of the present invention, the method comprising:

a solution preparation step of preparing a solution containing a rare earth element salt and a zirconium salt;

a first coating step of bringing the prepared solution into contact with a powder of at least one oxygen storage/release material selected from the group consisting of ceria-zirconia based solid solutions and alumina-doped ceria-zirconia based solid solutions to obtain a core-shell powder supporting the prepared solution in an amount which gives, after calcination to an oxide, 1 to 8 parts by mass of the rare earth-zirconia based composite oxide constituting a part of the shell relative to 100 parts by mass of the oxygen storage/release material constituting the core, followed by calcination at a temperature in a range from 600 to 1100° C. and then by grinding; and

a second coating step of bringing the prepared solution into contact with the obtained core-shell powder to obtain a core-shell powder additionally supporting the prepared solution in an amount which gives, after calcination to an oxide, 1 to 8 parts by mass of the rare earth-zirconia based composite oxide constituting a part of the shell relative to 100 parts by mass of the oxygen storage/release material constituting the core, followed by calcination at a temperature in a range from 600 to 1100° C. and then by grinding,

the core-shell support being obtained by performing the second coating step until an amount of the rare earth-zirconia based composite oxide constituting the shell after the calcination to the oxide reaches 4 to 24 parts by mass relative to 100 parts by mass of the oxygen storage/release material constituting the core, and then

the catalyst for purification of exhaust gas being obtained by bringing a noble metal salt solution into contact with the core-shell support.

A method for purification of exhaust gas of the present invention is a method comprising purifying an exhaust gas emitted from an internal combustion engine by bringing the exhaust gas into contact with the above-described catalyst for purification of exhaust gas of the present invention.

Note that although it is not exactly clear why the catalyst of the present invention achieves the above-described object, the present inventors speculate as follows. Specifically, since the noble metal such as Rh is supported on the oxygen storage/release material such as CeO₂ in the conventional catalyst, the conversion of the noble metal to its metallic state is inhibited, and exhaust gas purification activities, especially the NOx removal activity, decrease. However, an oxygen storage/release (OSC) material mainly containing CeO₂ or the like is necessary in a three-way catalyst. In other words, the improvement in NOx removal activity of a Rh catalyst and the provision of OSC are considered to be in a trade-off relationship.

In the present invention, the core-shell support comprises: the core comprising at least one oxygen storage/release material selected from the group consisting of ceria-zirconia based solid solutions and alumina-doped ceria-zirconia based solid solutions; and the shell which comprises a rare earth-zirconia based composite oxide represented by the composition formula: (Re₁₋ₓCeₓ)₂Zr₂O₇₊ₓ (where Re represents a rare earth element, and x represents a number of 0.0 to 0.8) and with which an outside of the core is coated. In addition, the rare earth-zirconia based composite oxide comprises crystal particles having a pyrochlore structure, and the average crystallite diameter of the rare earth-zirconia based composite oxide is limited in the range from 3 to 9 nm. Hence, in the obtained core-shell support, Ce-poor (Re₁₋ₓCeₓ)₂Zr₂O₇₊ₓ, including Re₂Zr₂O₇, stabilized by the pyrochlore structure is formed as the shell on the Ce-rich OSC material (at least one oxygen storage/release material selected from the group consisting of ceria-zirconia based solid solutions and alumina-doped ceria-zirconia based solid solutions) serving as the core. The present inventors speculate that the supporting of the noble metal on such a core-shell support improves the reducibility of the noble metal, enabling more improvement in the NOx removal activity in this case than in a case of a noble metal-supporting OSC material. In addition, the present inventors speculate that the NOx removal activity and the oxygen storage/release capacity, which have conventionally been considered to be in a trade-off relationship, can be achieved simultaneously at high levels, and this makes it possible to provide a core-shell support which enables both sufficiently good oxygen storage/release capacity (OSC) and sufficiently good NOx removal activity to be exhibited, a method for producing the core-shell support, a catalyst for purification of exhaust gas using the core-shell support, a method for producing the catalyst, and a method for purification of exhaust gas using the catalyst for purification of exhaust gas.

### Advantageous Effects of Invention

According to the present invention, it is possible to provide a core-shell support which enables both sufficiently good oxygen storage/release capacity (OSC) and sufficiently good NOx removal activity to be exhibited, a method for producing the core-shell support, a catalyst for purification of exhaust gas using the core-shell support, a method for producing the catalyst, and a method for purification of exhaust gas using the catalyst for purification of exhaust gas.

### BRIEF DESCRIPTION OF DRAWINGS

FIG. 1 is a graph showing the 50% NOx removal temperatures (NOx_T50) of catalysts obtained in Examples 1 to 6 and Comparative Examples 1 to 4.

FIG. 2 is a graph showing the transient NOx removal ratios of the catalysts obtained in Examples 1 to 6 and Comparative Examples 1 to 4.

FIG. 3 is a graph showing the OSC rates of the catalysts obtained in Examples 1 to 6 and Comparative Examples 1 to 4.

FIG. 4 shows graphs showing the maximum oxygen storage (OSC) and the NOx emission of catalysts of Examples 7 to 9 and Comparative Examples 5 to 7 (after an accelerated deterioration treatment). Note that the bar graph shows the maximum oxygen storage (OSC), and the line graph shows the NOx emission.

### DESCRIPTION OF EMBODIMENTS

Hereinafter, the present invention will be described in detail based on preferred embodiments thereof.

[Core-Shell Support]

A core-shell support of the present invention is described. The core-shell support of the present invention comprises:

a core which comprises at least one oxygen storage/release material selected from the group consisting of ceria-zirconia based solid solutions and alumina-doped ceria-zirconia based solid solutions; and

a shell which comprises a rare earth-zirconia based composite oxide represented by a composition formula: (Re₁₋ₓCeₓ)₂Zr₂O₇₊ₓ (where Re represents a rare earth element, and x represents a number of 0.0 to 0.8) and with which an outside of the core is coated, wherein

the rare earth-zirconia based composite oxide comprises crystal particles having a pyrochlore structure, and

the rare earth-zirconia based composite oxide has an average crystallite diameter of 3 to 9 nm.

(Core)

The core in the core-shell support of the present invention needs to comprise at least one oxygen storage/release material selected from the group consisting of ceria-zirconia based solid solutions and alumina-doped ceria-zirconia based solid solutions. The core of the core-shell support of the present invention has oxygen storage/release capacity (OSC: Oxygen Storage Capacity).

The ceria-zirconia based solid solution in the core of the core-shell support of the present invention is not particularly limited, and specific examples thereof include CeO₂—ZrO₂ solid solutions, CeO₂—ZrO₂—La₂O₃ solid solutions, CeO₂—ZrO₂—La₂O₃—Y₂O₃ solid solutions, CeO₂—PrO₂—ZrO₂—La₂O₃—Y₂O₃ solid solutions, CeO₂—ZrO₂—La₂O₃ solid solutions, CeO₂—ZrO₂—PrO₂ solid solutions, and CeO₂—ZrO₂—La₂O₃—Y₂O₃—Nd₂O₃ solid solutions. Especially, from the viewpoints of the OSC performance and the heat resistance, the ceria-zirconia based solid solution is preferably at least one selected from the group consisting of CeO₂—ZrO₂ solid solutions, CeO₂—ZrO₂—La₂O₃ solid solutions, CeO₂—ZrO₂—La₂O₃—Y₂O₃ solid solutions, and CeO₂—ZrO₂—PrO₂ solid solutions.

The ceria-zirconia based solid solution preferably contains 10 to 70% by mass of CeO₂ and 30 to 90% by mass of ZrO₂ relative to a total mass of the solid solution. In addition, when the ceria-zirconia based solid solution contains metal oxides other than CeO₂ and ZrO₂, it is preferable that the metal oxides be each independently contained at a ratio of 0.5 to 10% by mass relative to the total mass of the solid solution.

It is preferable to use, as the ceria-zirconia based solid solution, a solid solution in which ceria and zirconia are mixed with each other at an atomic level from the viewpoint of sufficiently forming an ordered phase. In addition, the ceria-zirconia based solid solution preferably has an average primary particle diameter of 10 nm or less. If the average primary particle diameter of the ceria-zirconia based solid solution exceeds the upper limit, the OSC performance, especially, the OSC reaction rate tends to be insufficient.

Meanwhile, the alumina-doped ceria-zirconia based solid solution in the core of the core-shell support of the present invention is not particularly limited, and specific examples thereof include Al₂O₃-doped CeO₂—ZrO₂ solid solutions, Al₂O₃ doped-CeO₂—ZrO₂—La₂O₃ solid solutions, Al₂O₃-doped CeO₂—ZrO₂—La₂O₃—Y₂O₃—Nd₂O₃ solid solutions, and Al₂O₃-doped CeO₂—ZrO₂—PrO₂—La₂O₃—Y₂O₃ solid solutions. Especially, from the viewpoints of the OSC performance and the heat resistance, the alumina-doped ceria-zirconia based solid solution is preferably at least one selected from the group consisting of Al₂O₃-doped CeO₂—ZrO₂ solid solutions, Al₂O₃ doped-CeO₂—ZrO₂—La₂O₃ solid solutions, and Al₂O₃-doped CeO₂—ZrO₂—La₂O₃—Y₂O₃—Nd₂O₃ solid solutions.

The alumina-doped ceria-zirconia based solid solution preferably contains 10 to 70% by mass of Al₂O₃, 10 to 70% by mass of CeO₂, and 30 to 80% by mass of ZrO₂ relative to the total mass of the solid solution. In addition, when the alumina-doped ceria-zirconia based solid solution contains metal oxides other than Al₂O₃, CeO₂, and ZrO₂, it is preferable that the metal oxides be each independently contained at a ratio of 0.5 to 10% by mass relative to the total mass of the solid solution.

It is preferable to use, as the alumina-doped ceria-zirconia based solid solution, a solid solution in which ceria and zirconia are mixed with each other at an atomic level and which is doped with alumina in an amorphous form or in the form of γ-alumina or θ-alumina, from the viewpoint of sufficiently forming an ordered phase. In addition, the alumina-doped ceria-zirconia based solid solution preferably has an average primary particle diameter of 10 nm or less. If the average CeO₂—ZrO₂ primary particle diameter of the alumina-doped ceria-zirconia based solid solution exceeds the upper limit, the OSC performance, especially, the OSC reaction rate tends to be insufficient.

In addition, the use of the alumina-doped ceria-zirconia based solid solution as the core according to the core-shell support of the present invention is preferable, because a surface layer enriched with Re₂Zr₂O₇ is further formed on a part of a surface of alumina, so that, for example, the deactivation of the noble metal such as Rh in an oxidizing atmosphere due to the embedding of the noble metal in the alumina can be inhibited.

Moreover, from the viewpoints of improving the heat stability of the support and the catalytic activity of the noble metal, the core according to the core-shell support of the present invention (at least one oxygen storage/release material selected from the group consisting of ceria-zirconia based solid solutions and alumina-doped ceria-zirconia based solid solutions) can be doped with dopants, as appropriate, unless an effect of the present invention is impaired. As the dopants, it is possible to use, for example, any of oxides of metals including rare earths, alkali metals, alkaline earth metals, transition metals, and the like such as lanthanum (La), yttrium (Y), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), magnesium (Mg), calcium (Ca), strontium (Sr), barium (Ba), scandium (Sc), and vanadium (V), mixtures of oxides of these metals, solid solutions of oxides of these metals, composite oxides of these metals, as appropriate.

In addition, a secondary particle diameter (aggregate particle diameter) of at least one oxygen storage/release material selected from the group consisting of ceria-zirconia based solid solutions and alumina-doped ceria-zirconia based solid solutions of the core in the core-shell support of the present invention is not particularly limited, and the secondary particle diameter is specifically about 100 nm to 100 μm, and preferably in a range from 100 nm to 10 μm from the viewpoint of use as a coat layer of a catalyst for purification of exhaust gas.

Moreover, the form of the core is not particularly limited, and the core is preferably in a form of powder. In addition, it is possible to use, as the core, one selected from the group consisting of ceria-zirconia based solid solutions and alumina-doped ceria-zirconia based solid solutions alone, or two selected therefrom in combination.

Moreover, a method for producing such a ceria-zirconia based solid solution or alumina-doped ceria-zirconia based solid solution is not particularly limited, and a known method can be employed, as appropriate. Moreover, commercially available one may be used as the ceria-zirconia based solid solution or the alumina-doped ceria-zirconia based solid solution.

(Shell)

Next, the shell in the core-shell support of the present invention needs to comprise a rare earth-zirconia based composite oxide represented by the composition formula: (Re₁₋ₓCeₓ)₂Zr₂O₇₊ₓ (where Re represents a rare earth element, and x represents a number of 0.0 to 0.8). If x in the composition formula of the rare earth-zirconia based composite oxide exceeds the upper limit, the composite oxide is so rich in Ce that the conversion of the noble metal such as Rh to its metallic state is inhibited. This lowers the catalytic activity, so that a sufficient NOx removal activity cannot be obtained. x is preferably a number of 0.1 to 0.8, and particularly preferably a number of 0.5 to 0.7, from the viewpoint of obtaining a core-shell support which offers both sufficiently high oxygen storage/release capacity (OSC) and sufficiently high NOx removal activity, and which exhibits sufficiently good oxygen storage/release capacity (OSC), even after exposed to high temperature for a long period.

Note that the composition of the rare earth-zirconia based composite oxide can be determined by a composition analysis based on ICP emission spectroscopy (plasma emission spectroscopy) using an inductively coupled plasma (ICP) emission spectrometer, or a composition analysis using any one of or a suitable combination of any ones of an X-ray fluorescence analyzer (XRF: X-ray Fluorescence Analysis), an EDX (energy-dispersive X-ray spectrometer), an XPS (photoelectron spectrometer), a SIMS (secondary ion mass spectrometer), an HR-TEM (high-resolution transmission electron microscope), an FE-STEM (field emission-scanning transmission electron microscope), and the like. Specifically, for example, after the powder is dissolved in an acid, a composition analysis is conducted by measuring the weight ratio of cation species in the obtained solution by ICP emission spectroscopy, to perform the composition analysis of the rare earth-zirconia based composite oxide.

In addition, Re in the composition formula of the rare earth-zirconia based composite oxide needs to be a rare earth element. specific examples of Re include lanthanum (La), neodymium (Nd), praseodymium (Pr), cerium (Ce), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), scandium (Sc), and yttrium (Y). The rare earth-zirconia based composite oxide may contain one of these elements alone or a combination of two or more thereof. Of these elements, from the viewpoints of the price of the material and the NOx removal activity, Re in the composition formula of the rare earth-zirconia based composite oxide is preferably at least one element selected from the group consisting of lanthanum (La), neodymium (Nd), praseodymium (Pr), and yttrium (Y), and more preferably at least one element selected from the group consisting of La, Nd, and Y.

In addition, regarding the rare earth-zirconia based composite oxide in the shell according to the core-shell support of the present invention needs to comprise crystal particles having a pyrochlore structure. The phrase “the rare earth-zirconia based composite oxide has a pyrochlore structure” means that Re ions, cerium ions, and zirconium ions in the composition formula form a crystal phase (pyrochlore phase) having a pyrochlore-type regularly arranged structure. The pyrochlore ReCZ has oxygen-defect sites. When oxygen atoms enter the sites, the pyrochlore phase undergoes a phase transition to a κ phase (kappa-phase). Meanwhile, the κ phase can undergo a phase transition to the pyrochlore phase by releasing oxygen atoms. A rare earth-zirconia based composite oxide having a pyrochlore structure has an oxygen storage/release (OSC) function based on the above-described change in the number of oxygen atoms in the lattice. Note that the crystal phase of the rare earth-zirconia based composite oxide can be determined by X-ray diffraction (XRD) measurement using CuKα radiation. The pyrochlore phase can be confirmed by checking a characteristic peak at around 2θ=14.20 (degrees) in an XRD pattern of the rare earth-zirconia based composite oxide.

In addition, the rare earth-zirconiabased composite oxide in the shell according to the core-shell support of the present invention needs to have an average crystallite diameter in a range from 3 to 9 nm. Suppose a case where the average crystallite diameter of the rare earth-zirconia based composite oxide is less than the lower limit. If a catalyst is prepared by supporting a noble metal on such a rare earth-zirconia based composite oxide, the noble metal (Rh or the like) becomes difficult to reduce because of the interaction between CeO₂ and the noble metal (Rh or and the like), so that the NOx removal activity decreases, and the NOx removal performance cannot be obtained sufficiently. Meanwhile, if the average crystallite diameter exceeds the upper limit, there arises a problem of remarkable lowering of the OSC performance. In addition, the average crystallite diameter of the rare earth-zirconia based composite oxide is preferably 1 to 20 nm, from the viewpoint of obtaining a core-shell support which offers both sufficiently high oxygen storage/release capacity (OSC) and sufficiently high NOx removal activity, and which exhibits sufficiently good oxygen storage/release capacity (OSC), even after exposed to high temperature for a long period. Note that the crystallite diameter can be determined by, for example, a method in which the crystallite diameter is determined by an analysis based on powder X-ray diffractometry, a method in which the crystallite diameter is determined by observation under a transmission electron microscope (TEM), a scanning electron microscope (SEM), or the like. For example, when the crystallite diameter is determined by the powder X-ray diffractometry, the rare earth-zirconia based composite oxide is analyzed by powder X-ray diffractometry, and a half width Bₕₖₗ (rad) of the diffraction peak of a predetermined crystal plane (hkl) is obtained from the obtained diffraction pattern. Then, an average value Dₕₖₗ (nm) of crystallite diameters in a direction perpendicular to the (hKl) crystal plane of the particles of the rare earth-zirconia based composite oxide can be calculated by using the Scherrer equation: Dₕₖₗ=KΔ/Bₕₖₗ cos θₕₖₗ. In the Scherrer equation, the constant K is 0.9, λ is a wavelength (nm) of the X-rays, and θₕₖₗ is a diffraction angle (degrees, °). In addition, the term “average crystallite diameter” refers to an average value D₄₄₀ (nm) of crystallite diameters in a direction perpendicular to the (440) plane, which is a value determined by powder X-ray diffractometry.

Moreover, the amount of the rare earth-zirconia based composite oxide supported on the core in the core-shell support of the present invention is not particularly limited, and preferably 4 to 24 parts by mass, and more preferably 8 to 18 parts by mass relative to 100 parts by mass of the core (at least one oxygen storage/release material selected from the group consisting of ceria-zirconia based solid solutions and alumina-doped ceria-zirconia based solid solutions). If the amount of the active component supported is less than the lower limit, the obtained catalytic activity tends to be insufficient, and the NOx removal ratio tends to decrease. Meanwhile, if the amount of the active component supported exceeds the upper limit, the cost of the catalyst tends to increase, and the activity of the catalyst (OSC) tends to decrease. In addition, a method for supporting the rare earth-zirconia based composite oxide on the core is not particularly limited, and a known method by which components of the rare earth-zirconia based composite oxide can be supported on the core can be employed, as appropriate. For example, a method may be employed in which the core is impregnated with an aqueous solution containing salts of metals which are components of the rare earth-zirconia based composite oxide, followed by drying and calcination.

[Catalysts for Purification of Exhaust Gas]

Next, catalysts for purification of exhaust gas of the present invention are described.

(First Catalyst for Purification of Exhaust Gas of the Present Invention)

A first catalyst for purification of exhaust gas of the present invention comprises: the above-described core-shell support of the present invention; and a noble metal supported on the core-shell support.

The noble metal in the catalyst for purification of exhaust gas of the present invention is not particularly limited, and examples thereof include platinum (Pt), rhodium (Rh), palladium (Pd), osmium (Os), iridium (Ir), gold (Au), and the like. One of these noble metals may be used alone, or two or more thereof may be used in combination. Of these noble metals, platinum, rhodium, and palladium are preferable, and rhodium is particularly preferable, from the viewpoint of obtaining a catalyst for purification of exhaust gas which has both sufficiently high oxygen storage/release capacity (OSC) and sufficiently high NOx removal activity. The amount of the noble metal supported is not particularly limited, and is adjusted, as appropriate, according to an application of the obtained catalyst or the like. The amount of the noble metal supported is preferably 0.05 to 10 parts by mass relative to 100 parts by mass of the core-shell support.

In addition, a form of the catalyst for purification of exhaust gas of the present invention is not particularly limited, and, for example, the catalyst may be used in a form of particles as it is, or in a form of a honeycomb-shaped monolithic catalyst in which the catalyst is supported on a substrate, a form of a pellet catalyst obtained by shaping the catalyst into pellets, or the like. Methods for producing catalysts in such forms are not particularly limited, and known methods can be employed, as appropriate. For example, it is possible to employ, as appropriate, a method in which a pellet-shaped catalyst is obtained by shaping the catalyst into pellets, a method in which the catalyst in a coated (fixed) form on a catalyst substrate is obtained by coating the catalyst substrate with the catalyst, or the like. In addition, the catalyst substrate is not particularly limited, and is selected, as appropriate, according to, for example, an application of the obtained catalyst or the like. A monolithic honeycomb substrate, a pellet-shaped substrate, a plate-shaped substrate, or the like is preferably employed. In addition, a material of the catalyst substrate is not particularly limited, and, for example, a substrate made of a ceramic such as cordierite, silicon carbide, or mullite or a substrate made of a metal such as stainless steel containing chromium and aluminum is preferably employed. Moreover, other components (for example, NOx storage material and the like) usable for various catalysts may be supported, as appropriate, in the catalyst for purification of exhaust gas of the present invention, unless an effect of the catalyst is impaired.

(Second Catalyst for Purification of Exhaust Gas of the Present Invention)

A second catalyst for purification of exhaust gas of the present invention comprises: a substrate; and a catalyst layer disposed on the substrate, wherein the catalyst layer comprises the core-shell support of the present invention, alumina, and a noble metal.

In addition, in the second catalyst for purification of exhaust gas of the present invention, it is preferable that

(1) at least part of the noble metal be supported on the core-shell support, and/or

(2) the catalyst layer further comprise a zirconia-based support, and at least part of the noble metal be supported on the zirconia-based support.

The substrate in the second catalyst for purification of exhaust gas of the present invention is not particularly limited, and is selected, as appropriate, according to, for example, an application of the obtained catalyst or the like. A monolithic honeycomb substrate, a pellet-shaped substrate, a plate-shaped substrate, or the like is preferably employed. In addition, a material of the catalyst substrate is not particularly limited, and, for example, a substrate made of a ceramic such as cordierite, silicon carbide, or mullite or a substrate made of a metal such as stainless steel containing chromium and aluminum is preferably employed.

The noble metal in the second catalyst for purification of exhaust gas of the present invention is not particularly limited, and examples thereof include platinum (Pt), rhodium (Rh), palladium (Pd), osmium (Os), iridium (Ir), gold (Au), and the like. One of these noble metals may be used alone, or two or more thereof may be used in combination. Of these noble metals, platinum, rhodium, and palladium are preferable, and rhodium is particularly preferable, from the viewpoint of obtaining a catalyst for purification of exhaust gas which has both sufficiently high oxygen storage/release capacity (OSC) and sufficiently high NOx removal activity. The amount of the noble metal supported is not particularly limited, and is adjusted, as appropriate, according to an application of the obtained catalyst or the like. The amount of the noble metal supported is preferably 0.05 to 10 parts by mass relative to 100 parts by mass of the support.

The second catalyst for purification of exhaust gas of the present invention preferably contains 0.01 to 2.0 g/L of the noble metal, 50 to 180 g/L of the core-shell support of the present invention, and 20 to 150 g/L of alumina, per liter of the capacity of the substrate.

In addition, when the second catalyst for purification of exhaust gas of the present invention further comprises a zirconia-based support, the zirconia-based support is not particularly limited, and specific examples thereof include supports made of ZrO₂, Al₂O₃ doped-ZrO₂, ZrO₂—La₂O₃ solid solutions, Al₂O₃ doped-ZrO₂—La₂O₃ solid solutions, ZrO₂—La₂O₃—Y₂O₃ solid solutions, Al₂O₃ doped-ZrO₂—La₂O₃—Y₂O₃ solid solutions, ZrO₂—PrO₂ solid solutions, and Al₂O₃ doped-ZrO₂—PrO₂ solid solutions. In this case, the amount of the zirconia-based support is preferably 30 to 80 g/L, per liter of the capacity of the substrate.

In addition, in the second catalyst for purification of exhaust gas of the present invention, it is preferable that the catalyst layer be a rhodium-containing catalyst layer containing Rh as the noble metal, and a palladium-containing catalyst layer containing a ceria-zirconia based solid solution and/or an alumina-doped ceria-zirconia based solid solution, alumina, and Pd be disposed between the substrate and the rhodium-containing catalyst layer. Such a palladium-containing catalyst layer preferably contains 0.01 to 2.0 g/L of palladium, 10 to 60 g/L of the ceria-zirconia based solid solution and/or the alumina-doped ceria-zirconia based solid solution, and 20 to 70 g/L of alumina, per liter of the capacity of the substrate.

[Method for Producing Core-Shell Support]

Next, a method for producing a core-shell support of the present invention is descried. The method for producing a core-shell support of the present invention is a method for producing the above-described core-shell support of the present invention, comprising:

a solution preparation step of preparing a solution containing a rare earth element salt and a zirconium salt;

a first coating step of bringing the prepared solution into contact with a powder of at least one oxygen storage/release material selected from the group consisting of ceria-zirconia based solid solutions and alumina-doped ceria-zirconia based solid solutions to obtain a core-shell powder supporting the prepared solution in an amount which gives, after calcination to an oxide, 1 to 8 parts by mass of the rare earth-zirconia based composite oxide constituting a part of the shell relative to 100 parts by mass of the oxygen storage/release material constituting the core, followed by calcination at a temperature in a range from 600 to 1100° C. and then by grinding; and

a second coating step of bringing the prepared solution into contact with the obtained core-shell powder to obtain the core-shell powder additionally supporting the prepared solution in an amount which gives, after calcination to an oxide, 1 to 8 parts by mass of the rare earth-zirconia based composite oxide constituting a part of the shell relative to 100 parts by mass of the oxygen storage/release material constituting the core, followed by calcination at a temperature in a range from 600 to 1100° C. and then by grinding, wherein

the core-shell support is obtained by performing the second coating step until an amount of the rare earth-zirconia based composite oxide constituting the shell after the calcination to the oxide reaches 4 to 24 parts by mass relative to 100 parts by mass of the oxygen storage/release material constituting the core.

(Solution Preparation Step)

In the method for producing a core-shell support of the present invention, first, a solution containing a rare earth element salt and a zirconium salt is prepared (solution preparation step).

The rare earth element salt in the solution is not particularly limited, and examples thereof include rare earth element salts such as nitrates, sulfates, halides (fluorides, chlorides, and the like), acetates, carbonates, and organic acid salts (for example, citrates) of rare earth elements, and complexes thereof. Of these salts, the rare earth element salt is preferably at least one selected from the group consisting of nitrates, acetates, carbonates, and citrates, from the viewpoints of the uniform supporting on the core and of the cost and from the viewpoint that components remaining in the shell during the preparation can be removed relatively easily. As the rare earth element in the solution, the same rare earth elements as descried for the core-shell support of the present invention can be used.

Meanwhile, examples of the zirconium (Zr) salt in the solution include zirconium salts such as nitrates (for example, zirconium oxynitrate and zirconyl oxynitrate), sulfates, halides (fluorides, chlorides, and the like), acetates, carbonates, and citrates of zirconium, and complexes thereof. Of these zirconium salts, it is more preferable to use, as the Zr salt, at least one selected from the group consisting of nitrates and acetates, from the viewpoints of the uniform supporting on the core and of the cost and from the viewpoint that components remaining in the shell during the preparation can be removed relatively easily.

Moreover, a solvent is not particularly limited, and examples thereof include water (preferably pure water such as ion-exchanged water or distilled water), and the like.

Note that concentrations in the solution containing a rare earth element salt and a zirconium salt are not particularly limited, and the concentration of the rare earth element ions is preferably in a range from 0.001 to 0.1 mol/L, and the concentration of zirconium (Zr) ions is preferably in a range from 0.001 to 0.1 mol/L.

(First Coating Step)

Next, the prepared solution is brought into contact with a powder of at least one oxygen storage/release material selected from the group consisting of ceria-zirconia based solid solutions and alumina-doped ceria-zirconia based solid solutions to obtain a core-shell powder supporting the prepared solution in an amount which gives, after calcination to an oxide, 1 to 8 parts by mass of the rare earth-zirconia based composite oxide constituting a part of the shell relative to 100 parts by mass of the oxygen storage/release material constituting the core, followed by calcination at a temperature in a range from 600 to 1100° C. and then by grinding (first coating step).

A method for bringing the solution into contact with the powder of at least one oxygen storage/release material selected from the group consisting of ceria-zirconia based solid solutions and alumina-doped ceria-zirconia based solid solutions is not particularly limited, and it is possible to employ, as appropriate, a known method by which the solution can be supported on the powder by adsorption, such as a method in which the powder is impregnated with the solution, a method in which the solution is supported on the powder by adsorption, a method in which the solution is impregnated with the powder, or the like.

In addition, when the solution is brought into contact with the powder of the oxygen storage/release material as described above, it is necessary to support the solution in an amount which gives, after calcination to an oxide, 1 to 8 parts by mass of the rare earth-zirconia based composite oxide constituting a part of the shell relative to 100 parts by mass of the oxygen storage/release material constituting the core. If the amount of the solution supported is less than the lower limit, exhibition of a sufficient catalytic activity is difficult. Meanwhile, if the amount of the solution supported exceeds the upper limit, the solution is supported unevenly or the composition becomes uneven, so that the catalytic activity decreases. Note that the amount of the solution supported is preferably an amount which gives, after calcination to an oxide, 2 to 6 parts by mass, and further preferably an amount which gives, after calcination to an oxide, 4 to 6 parts by mass of the rare earth-zirconia based composite oxide constituting a part of the shell relative to 100 parts by mass of the oxygen storage/release material constituting the core, from the viewpoint of supporting the solution with a uniform supporting density.

Moreover, a heating condition of the calcination needs to be in a temperature range from 600 to 1100° C. If the heating temperature for the calcination is lower than the lower limit, a pyrochlore phase, which is a desired and stable structure, is not formed. Meanwhile, if the heating temperature exceeds the upper limit, the specific surface area decreases, and a catalytic performance is remarkably degraded. The heating temperature is preferably in a temperature range from 800 to 1000° C. from the viewpoint of stabilizing the crystal phase of the shell material. In addition, a heating time of the calcination cannot be generally specified, because it depends on the heating temperature. However, the heating time is preferably 3 to 50 hours. Moreover, a calcination atmosphere is not particularly limited, and is preferably an air atmosphere or an oxidizing atmosphere.

In addition, the grinding is not particularly limited, and specifically either a dry grinding method or a wet grinding method can be used as the grinding method. Apparatuses for the grinding include a mortar, a ball mill, a mixer, and the like. When dry grinding is employed, the dry grinding may be performed by using a mortar. Alternatively, a grinding and mixing apparatus such as a ball mill, an attritor, or a planetary mill may be used. When wet grinding is employed, a solvent is used as an auxiliary agent for the grinding, and examples thereof include water, alcohols, and the like. Note that it is preferable to use a mortar, a mixer, or the like to perform the grinding, and a grinding condition is preferably such that the grinding is performed to an extent that the powder can pass a sieve with a predetermined powder diameter (about 100 nm to 100 μm).

(Second Coating Step)

Subsequently, the prepared solution is brought into contact with the obtained core-shell powder to obtain the core-shell powder additionally supporting the prepared solution in an amount which gives, after calcination to an oxide, 1 to 8 parts by mass of the rare earth-zirconia based composite oxide constituting a part of the shell relative to 100 parts by mass of the oxygen storage/release material constituting the core, followed by calcination at a temperature in a range from 600 to 1100° C. and then by grinding (second coating step).

A method for bringing the solution into contact with the obtained core-shell powder is not particularly limited, and it is possible to employ, as appropriate, a known method by which the solution can be supported on the powder by adsorption such as a method in which the powder is impregnated with the solution, a method in which the solution is supported on the powder by adsorption, a method in which the solution is impregnated with the powder, or the like. Methods which are the same as the contact methods described for the first coating step can be used.

In addition, a method for bringing the solution into contact with the powder of at least one oxygen storage/release material selected from the group consisting of ceria-zirconia based solid solutions and alumina-doped ceria-zirconia based solid solutions is not particularly limited, and a known method can be employed, as appropriate, such as a method in which the powder is impregnated with the solution, a method in which the solution is supported on the powder by adsorption, or the like.

In addition, when the solution is brought into contact with the core-shell powder, it is necessary to additionally support the prepared solution in an amount which gives, after calcination to an oxide, 1 to 8 parts by mass of the rare earth-zirconia based composite oxide constituting a part of the shell relative to 100 parts by mass of the oxygen storage/release material constituting the core. If the amount of the solution supported is less than the lower limit, exhibition of a sufficient catalytic activity is difficult. Meanwhile, if the amount of the solution supported exceeds the upper limit, the solution is supported unevenly or the composition becomes uneven, so that the catalytic activity decreases. Note that the amount of the solution supported is preferably an amount which gives, after calcination to an oxide, 2 to 6 parts by mass and further preferably an amount which gives, after calcination to an oxide, 4 to 6 parts by mass of the rare earth-zirconia based composite oxide constituting a part of the shell relative to 100 parts by mass of the oxygen storage/release material constituting the core, from the viewpoint of supporting the solution with a uniform supporting density.

Moreover, a heating condition for the calcination needs to be in a temperature range from 600 to 1100° C. If the heating temperature for the calcination is lower than the lower limit, the pyrochlore phase, which is a desired stable structure, is not formed. Meanwhile, if the heating temperature exceeds the upper limit, the specific surface area decreases, and a catalytic performance is remarkably degraded. The heating temperature is preferably in a temperature range from 800 to 1000° C., from the viewpoint of stabilizing the crystal phase of the shell. In addition, a heating time of the calcination cannot be generally specified, because it depends on the heating temperature. However, the heating time is preferably 3 to 50 hours. Moreover, a calcination atmosphere is not particularly limited, and is preferably an air atmosphere, or at least an oxidizing atmosphere.

In addition, the grinding is not particularly limited, and the method, conditions, and the like for the grinding are the same as those described for the first coating step.

Moreover, regarding the second coating step according to the method for producing a core-shell of the present invention, the core-shell support is obtained by performing this second coating step until an amount of the rare earth-zirconia based composite oxide constituting the shell after the calcination to the oxide reaches 4 to 24 parts by mass relative to 100 parts by mass of the oxygen storage/release material constituting the core. Note that the second coating step is preferably performed once or twice. If so, a surface layer enriched with the rare earth element and zirconium can be deposited more uniformly on the core surface, so that the pyrochlore structure (Re₁₋ₓCeₓ)₂Zr₂O₇₊ₓ formed in the rare earth-zirconia based composite oxide constituting the shell can be further stabilized.

The method for producing a core-shell support of the present invention comprises the first coating step and the second coating step. Hence, in the method for forming the shell, the solution containing a rare earth element salt and a zirconium salt is supported with a small thickness by impregnation or adsorption multiple times in a divided manner on the powder of at least one oxygen storage/release material selected from the group consisting of ceria-zirconia based solid solutions and alumina-doped ceria-zirconia based solid solutions or on the core-shell powder. In addition, every time the supporting by impregnation or adsorption is performed, the high-temperature calcination and the grinding are carried out. Thus, a surface layer enriched with the rare earth element and zirconium can be uniformly deposited on the surface of the core, which is made of the OSC material, and a Ce-poor pyrochlore structure (Re₁₋ₓCeₓ)₂Zr₂O₇₊ₓ can be formed and stabilized in the rare earth-zirconia based composite oxide serving as the shell. Here, the Ce-poor pyrochlore structure (Re₁₋ₓCeₓ)₂Zr₂O₇₊ₓ is formed in such a manner that the high-temperature calcination causes Ce in the core, which is made of the OSC material, to be partially solid-dissolved in the shell.

[Method for Producing Catalyst for Purification of Exhaust Gas]

Next, a method for producing a catalyst for purification of exhaust gas of the present invention is described. The method for producing a catalyst for purification of exhaust gas of the present invention is a method for producing the above-described first catalyst for purification of exhaust gas of the present invention, comprising:

a solution preparation step of preparing a solution containing a rare earth element salt and a zirconium salt;

a first coating step of bringing the prepared solution into contact with a powder of at least one oxygen storage/release material selected from the group consisting of ceria-zirconia based solid solutions and alumina-doped ceria-zirconia based solid solutions to obtain a core-shell powder supporting the prepared solution in an amount which gives, after calcination to an oxide, 1 to 8 parts by mass of the rare earth-zirconia based composite oxide constituting a part of the shell relative to 100 parts by mass of the oxygen storage/release material constituting the core, followed by calcination at a temperature in a range from 600 to 1100° C. and then by grinding;

a second coating step of bringing the prepared solution into contact with the obtained core-shell powder to obtain the core-shell powder additionally supporting the prepared solution in an amount which gives, after calcination to an oxide, 1 to 8 parts by mass of the rare earth-zirconia based composite oxide constituting a part of the shell relative to 100 parts by mass of the oxygen storage/release material constituting the core, followed by calcination at a temperature in a range from 600 to 1100° C. and then by grinding, wherein

the core-shell support is obtained by performing the second coating step until an amount of the rare earth-zirconia based composite oxide constituting the shell after the calcination to the oxide reaches 4 to 24 parts by mass relative to 100 parts by mass of the oxygen storage/release material constituting the core, and then

the catalyst for purification of exhaust gas is obtained by bringing a noble metal salt solution into contact with the core-shell support.

In the method for producing a catalyst for purification of exhaust gas of the present invention, the solution preparation step, the first coating step, and the second coating step are the same as the solution preparation step, the first coating step, and the second coating step described for the method for producing a core-shell support.

Next, the catalyst for purification of exhaust gas is obtained by bringing a noble metal salt solution into contact with the core-shell support (catalyst preparation step). A specific method for bringing the noble metal salt solution into contact with the core-shell support in this catalyst preparation step is not particularly limited, and a method is preferably used in which the core-shell support is immersed in a solution obtained by dissolving a salt (nitrate, chloride, acetate, or the like) of the noble metal or a complex of the noble metal in a solvent such as water or an alcohol, and, after removal of the solvent, the core-shell support is calcined and ground, for example.

Note that, in the catalyst preparation step, drying conditions for removing the solvent are preferably about 180 minutes or less at 150 to 200° C., whereas calcination conditions are preferably about 3 to 5 hours at 300 to 400° C. in an oxidizing atmosphere (for example, air). Moreover, such a step of supporting the noble metal may be repeated, until a desired amount of the noble metal supported is achieved.

In addition, the noble metal supported in the method for producing a catalyst for purification of exhaust gas of the present invention is preferably platinum, rhodium, or palladium, and particularly preferably Rh, from the viewpoint of obtaining a catalyst for purification of exhaust gas which has both sufficiently high oxygen storage/release capacity (OSC) and sufficiently high NOx removal activity.

[Method for Purification of Exhaust Gas]

Next, a method for purification of exhaust gas of the present invention is described. The method for purification of exhaust gas of the present invention is a method comprising purifying an exhaust gas exhaust gas emitted from an internal combustion engine by bringing the exhaust gas into contact with the above-described catalyst for purification of exhaust gas of the present invention.

In the method for purification of exhaust gas of the present invention, a method for bringing the exhaust gas into contact with the catalyst for purification of exhaust gas of the present invention is not particularly limited, and a known method can be employed, as appropriate. For example, a method may be employed in which the exhaust gas from an internal combustion engine is brought into contact with the catalyst for purification of exhaust gas according to the present invention by disposing the catalyst for purification of exhaust gas in an exhaust pipe through which the gas emitted from the internal combustion engine flows.

Note that the above-described catalyst for purification of exhaust gas of the present invention used in the method for purification of exhaust gas of the present invention has both sufficiently good oxygen storage/release capacity (OSC) and sufficiently good NOx removal activity. Hence, the catalyst for purification of exhaust gas of the present invention can exhibit both sufficiently good oxygen storage/release capacity (OSC) and sufficiently good NOx removal activity. When an exhaust gas from, for example, an internal combustion engine is brought into contact with the catalyst for purification of exhaust gas of the present invention, the catalyst for purification of exhaust gas of the present invention can exhibit both sufficiently high oxygen storage/release capacity (OSC) and sufficiently high NOx removal activity, so that harmful gases such as NOx contained in the exhaust gas can be removed sufficiently. From such viewpoints, the method for purification of exhaust gas of the present invention can be employed suitably as a method for removing, for example, harmful components such as harmful gases (hydrocarbons (HCs), carbon monoxide (CO), and nitrogen oxides (NOx)) contained in an exhaust gas emitted from an internal combustion engine in an automobile etc., or the like.

### EXAMPLES

Hereinafter, the present invention will be described more specifically on the basis of Examples and Comparative Examples; however, the present invention is not limited to Examples below.

### Example 1

First, 10 g of a ceria-zirconia based solid solution powder was prepared with a composition (% by mass) of CeO₂:ZrO₂:La₂O₃:Y₂O₃=30:60:5:5, an average particle diameter of 5 μm, and a specific surface area of 70 m²/g. Subsequently, a solution was prepared by dissolving 0.7×10³ mol of zirconyl oxynitrate (manufactured by Wako Pure Chemical Industries, Ltd.) and 0.7×10³ mol of lanthanum nitrate hexahydrate (manufactured by Wako Pure Chemical Industries, Ltd.) in 100 ml of ion-exchanged water (solution preparation step).

Next, 10 g of the ceria-zirconia based solid solution powder was added to the prepared solution, followed by stirring for 15 minutes. Further, the mixture was heated with stirring to impregnate the ceria-zirconia based solid solution powder with the solution (supporting by impregnation). Then, this impregnated powder was evaporated to dryness to obtain coagulation (evaporation to dryness). Subsequently, the obtained coagulation was calcined in air under a temperature condition of 900° C. for 5 hours, and then ground into a powder by using a mortar for 30 minutes or more to obtain a core-shell powder (first coating step).

Subsequently, a core-shell support was obtained by performing a single series of processes in which the solution was supported on the obtained core-shell powder by impregnation in the same manner as in the above-described first coating step, and then the impregnated powder was evaporated to dryness, followed by calcination and grinding (second coating step).

Next, the obtained core-shell support was impregnated with 0.1 L of a rhodium nitrate solution containing 0.015 g of rhodium (Rh) in terms of metal, and then this impregnated support was evaporated to dryness by heating with stirring in air under a temperature condition of 200° C. for 120 minutes to obtain coagulation (evaporation to dryness). Subsequently, a powdery catalyst for purification of exhaust gas was obtained by calcination in air under a temperature condition of 300° C. for 5 hours. Note that the amount of rhodium supported in the obtained catalyst for purification of exhaust gas was 0.15% by mass relative to 100% by mass of the core-shell support.

### Example 2

A core-shell support was obtained in the same manner as in Example 1, except that the amounts of zirconyl oxynitrate and lanthanum nitrate dissolved were each changed to 2.1×10³ mol. Moreover, a powdery catalyst for purification of exhaust gas was obtained by supporting Rh as the noble metal on the obtained core-shell support in the same manner as in Example 1. Note that the amount of rhodium supported in the obtained catalyst for purification of exhaust gas was 0.15% by mass relative to 100% by mass of the core-shell support.

### Example 3

A core-shell support was obtained in the same manner as in Example 1, except that the second coating step (another series of processes of the supporting of the solution by impregnation, the evaporation to dryness, and the calcination and grinding) was conducted once more on the obtained core-shell powder with each of the amounts of zirconyl oxynitrate and lanthanum nitrate dissolved being 2.1×10³ mol (the second coating step was conducted twice in total). Moreover, a powdery catalyst for purification of exhaust gas was obtained by supporting Rh as the noble metal on the obtained core-shell support in the same manner as in Example 1. Note that the amount of rhodium supported in the obtained catalyst for purification of exhaust gas was 0.15% by mass relative to 100% by mass of the core-shell support.

### Example 4

A core-shell support was obtained in the same manner as in Example 3, except that neodymium nitrate (dissolved amount: 2.1×10³ mol) was further added to the prepared solution. Moreover, a powdery catalyst for purification of exhaust gas was obtained by supporting Rh as the noble metal on the obtained core-shell support in the same manner as in Example 1. Note that the amount of rhodium supported in the obtained catalyst for purification of exhaust gas was 0.15% by mass relative to 100% by mass of the core-shell support.

### Example 5

A core-shell support was obtained in the same manner as in Example 1, except that an alumina-doped ceria-zirconia based solid solution powder with a composition (% by mass) of Al₂O₃:CeO₂: ZrO₂: La₂O₃:Y₂O₃:Y₂O₃:Nd₂O₃=30:20:44:2:2:2, an average particle diameter of 8 μm, and a specific surface area of 70 m²/g was used instead of the ceria-zirconia based solid solution powder, and the amounts of zirconyl oxynitrate and lanthanum nitrate dissolved were each changed to 2.1×10³ mol. Moreover, a powdery catalyst for purification of exhaust gas was obtained by supporting Rh as the noble metal on the obtained core-shell support in the same manner as in Example 1. Note that the amount of rhodium supported in the obtained catalyst for purification of exhaust gas was 0.15% by mass relative to 100% by mass of the core-shell support.

### Example 6

A core-shell powder was obtained in the same manner as in Example 1, except that an alumina-doped ceria-zirconia based solid solution powder with a composition (% by mass) of Al₂O₃:CeO₂:ZrO₂: La₂O₃: Y₂O₃:Y₂O₃:Nd₂O₃=30:20:44:2:2:2, an average particle diameter of 8 μm, and a specific surface area of 70 m²/g was used instead of the ceria-zirconia based solid solution powder, that the amounts of zirconyl oxynitrate and lanthanum nitrate dissolved were each changed to 2.1×10³ mol, and further that the second coating step (another series of processes of the supporting of the solution by impregnation, the evaporation to dryness, and the calcination and grinding) was conducted once more (the second coating step was conducted twice in total) on the obtained core-shell powder. Moreover, a powdery catalyst for purification of exhaust gas was obtained by supporting Rh as the noble metal on the obtained core-shell powder in the same manner as in Example 1. Note that the amount of rhodium supported in the obtained catalyst for purification of exhaust gas was 0.15% by mass relative to 100% by mass of the core-shell support.

### Comparative Example 1

As a catalyst support for comparison, 10 g of a ceria-zirconia based solid solution powder (with a composition (% by mass) of CeO₂:ZrO₂:La₂O₃:Y₂O₃=30:60:5:5, an average particle diameter of 8 μm, and a specific surface area of 60 m²/g) was used. Next, a powdery catalyst for comparison was obtained by supporting Rh as the noble metal on 10 g of the powder of the catalyst support for comparison in the same manner as in Example 1. Note that the amount of rhodium supported in the obtained powder of the catalyst for comparison was 0.15% by mass relative to 100% by mass of the catalyst support for comparison.

### Comparative Example 2

As a catalyst support for comparison, 10 g of an alumina-doped ceria-zirconia based solid solution powder (with a composition (% by mass) of Al₂O₃:CeO₂:ZrO₂: La₂O₃: Y₂O₃:Y₂O₃:Nd₂O₃=30:20:44:2:2:2, an average particle diameter of 8 μm, and a specific surface area of 70 m²/g) was used. Next, a powdery catalyst for comparison was obtained by supporting Rh as the noble metal on 10 g of the powder of the catalyst support for comparison in the same manner as in Example 1. Note that the amount of rhodium supported in the obtained powder of the catalyst for comparison was 0.15% by mass relative to 100% by mass of the catalyst support for comparison.

### Comparative Example 3

First, 10 g of a ceria-zirconia based solid solution powder (with a composition (% by mass) of CeO₂:ZrO₂:La₂O₃:Y₂O₃=30:60:5:5, an average particle diameter of 8 μm, and a specific surface area of 60 m²/g) was prepared. Subsequently, a solution was prepared by dissolving 0.7×10³ mol of zirconyl oxynitrate dihydrate (manufactured by Wako Pure Chemical Industries, Ltd.) and 0.7×10⁻³ mol of lanthanum nitrate hexahydrate (manufactured by Wako Pure Chemical Industries, Ltd.) in 100 ml of ion-exchanged water.

Next, 10 g of the ceria-zirconia based solid solution powder was added to the prepared solution, followed by stirring for 15 minutes. Further, the mixture was heated with stirring to impregnate the ceria-zirconia based solid solution powder with the solution (supporting by impregnation). Then, this impregnated powder was evaporated to dryness to obtain coagulation (evaporation to dryness). Subsequently, the obtained coagulation was calcined in air under a temperature condition of 900° C. for 5 hours, and then ground into a powder by using a mortar for 30 minutes or more to obtain a catalyst support for comparison.

Subsequently, a powdery catalyst for comparison was obtained by supporting Rh as the noble metal on 10 g the powder of the catalyst support for comparison in the same manner as in Example 1. Note that the amount of rhodium supported in the obtained catalyst for comparison was 0.15% by mass relative to 100% by mass of the catalyst support for comparison.

### Comparative Example 4

First, 10 g of a ceria-zirconia based solid solution powder (with a composition (% by mass) of CeO₂:ZrO₂:La₂O₃:Y₂O₃=30:60:5:5, an average particle diameter of 8 μm, and a specific surface area of 60 m²/g) was prepared. Subsequently, a solution was prepared by dissolving 8.75×10³ mol of zirconyl oxynitrate dihydrate (manufactured by Wako Pure Chemical Industries, Ltd.) and 8.75×10⁻³ mol of lanthanum nitrate hexahydrate (manufactured by Wako Pure Chemical Industries, Ltd.) in 100 ml of ion-exchanged water.

Next, 10 g of the ceria-zirconia based solid solution powder was added to the prepared solution, followed by stirring for 15 minutes. Further, the mixture was heated with stirring to impregnate the ceria-zirconia based solid solution powder with the solution (supporting by impregnation). Then, this impregnated powder was evaporated to dryness to obtain coagulation (evaporation to dryness). Subsequently, the obtained coagulation was calcined in air under a temperature condition of 900° C. for 5 hours, and then ground into a powder by using a mortar for 30 minutes or more to obtain a catalyst support for comparison.

Subsequently, a powdery catalyst for comparison was obtained by supporting Rh as the noble metal on 10 g of the powder of the catalyst support for comparison in the same manner as in Example 1. Note that the amount of rhodium supported in the obtained catalyst for comparison was 0.15% by mass relative to 100% by mass of the catalyst support for comparison.

[X-Ray Diffraction (XRD) Measurement]

The average crystallite diameter (average primary particle diameter) of the shell (rare earth-zirconia based composite oxide) of each of the catalysts obtained in Examples 1 to 6 and Comparative Examples 3 and 4 was measured as follows.

First, by using each of the catalysts obtained in Examples 1 to 6 and Comparative Examples 3 and 4 used as a measurement sample, an X-ray diffraction (XRD) pattern of the shell (rare earth-zirconia based composite oxide) of the catalyst was obtained by measurement using a powder X-ray diffraction apparatus (a horizontal sample mounting type multi-purpose X-ray diffractometer manufactured by Rigaku Corporation under the trade name of “Ultima IV”) under the conditions of a scan step size of 0.02, a divergence slit of 8 degrees, a scattering slit of 8 degrees, a receiving slit of 10 mm, Cu Kα radiation (λ=0.15418 nm), 40 kV, 40 mA, and a scan rate of 10 degrees per minute. For the shell for which the XRD pattern was thus obtained, the average crystallite diameter (average primary particle diameter) was determined by calculation on the basis of the diffraction line width of a peak (20=10 to 80°) attributable to the rare earth-zirconia based composite oxide using the Scherrer equation:

D=0.89×λ/β cos θ

(where D represents a crystallite diameter, λ represents the wavelength of the X-ray used, β represents a diffraction line width of the XRD measurement sample, and θ represents a diffraction angle). Table 1 shows the obtained results.

As is apparent from the average crystallite diameter of the rare earth-zirconia based composite oxide of each of Examples 1 to 6 and Comparative Examples 3 and 4 at an initial stage shown in Table 1, it was found that the average crystallite diameter of the rare earth-zirconia based composite oxide of each of Examples 1 to 6 was in the range from 3 to 9 nm.

TABLE 1

| | Shell | | | Transient | |
|---|---|---|---|---|---|
| | (Rare earth-zirconia based | | Stoichiometric three- | NOx removal | |
| | composite oxide) | | way activity evaluation | activity evaluation | |
| | Average | | 50% NOx removal | Transient | OSC activity |
| | crystallite | | temperature | NOx removal | evaluation |
| | diameter | x in composition | (NOx_T50) | ratio | OSC rate |
| | [nm] | formula | [° C.] | [%] | [μmol-O₂/g/s] |
| Example 1 | 4 | 0.80 | 343 | 82 | 24 |
| Example 2 | 7 | 0.69 | 338 | 88 | 23 |
| Example 3 | 8 | 0.58 | 339 | 89 | 23 |
| Example 4 | 8 | 0.58 | 340 | 85 | 22 |
| Example 5 | 6 | 0.43 | 316 | 90.9 | 23 |
| Example 6 | 9 | 0.37 | 325 | 91.6 | 24 |
| Comp. Ex. 1 | — | 0.90 | 357 | 71 | 24 |
| Comp. Ex. 2 | — | 0.90 | 332 | 85.9 | 23.5 |
| Comp. Ex. 3 | 2 | 0.88 | 356 | 78 | 24 |
| Comp. Ex. 4 | 10 | 0.48 | 347 | 82 | 18 |

Next, the composition (composition formula: (Re₁₋ₓCeₓ)₂Zr₂O₇₊ₓ (where Re represents a rare earth element, and x represents a number of 0.0 to 0.8)) of the shell (rare earth-zirconia based composite oxide) of each of the catalysts obtained in Examples 1 to 6 and Comparative Examples 3 and 4 and x in the composition formula were determined as follows. Specifically, on an assumption that a lattice constant changed linearly between the lattice constant calculated from the peak position of Re₂Zr₂O₇ and the lattice constant calculated from the peak position of Ce₂Zr₂O₈, the amount of Ce in the shell material, i.e., the value of x was determined from the lattice constant calculated from the peak position of the shell material. Table 1 shows the obtained results.

In addition, the presence or absence of the pyrochlore phase was determined on the basis of the presence or absence of a peak at around 20=14.20 (degrees) after endurance.

[High-Temperature Endurance Treatment]

Each of the catalyst powders obtained in Examples 1 to 6 and Comparative Examples 1 to 4 was subjected to powder press molding by cold isostatic press (CIP) using an isostatic press (manufactured by NIKKISO CO., LTD. under the trade name of “CK4-22-60”) at a pressure (molding pressure) of 1000 kgf/cm² for 1 minute, followed by crushing and size selection to obtain 0.5 to 1.0 mm pellets. Thus, a pellet catalyst sample for an evaluation test (pellet-shaped catalyst for purification of exhaust gas) was obtained.

Next, the obtained pellet catalyst sample (1.5 g) was placed in a normal pressure fixed bed flow type reactor. Subsequently, a model gas treatment was conducted in which a lean (L) gas and a rich (R) gas having the gas compositions shown in Table 2 were passed alternately for 5 minutes each and 5 hours in total under a temperature condition of 1100° C. at a flow rate of 10 L (liters)/minute. In this manner, a high-temperature endurance treatment (endurance test) was conducted.

TABLE 2

| | O₂ | H₂ | CO₂ | |
|---|---|---|---|---|
| | (% by volume) | (% by volume) | (% by volume) | N₂ |
| Lean (L) | 1.0 | — | 10.0 | Balance |
| Rich (R) | — | 2.0 | 10.0 | Balance |

[Stoichiometric Three-Way Activity Evaluation Test]

The 50% NOx removal temperature (NOx_T50) of each of the catalysts obtained in Examples 1 to 6 and Comparative Examples 1 to 4 was measured by conducting a stoichiometric three-way activity evaluation test on the pellet catalyst sample subjected to the high-temperature endurance treatment by using a flow reactor and an exhaust gas analyzer as follows.

Specifically, first, the pellet catalyst sample subjected to the high-temperature endurance treatment was placed in a reaction tube (internal volume: 1.7 cm in diameter and 9.5 cm in length) of a normal pressure fixed bed flow type reactor. Note that the amount of the catalyst sample of each of Examples 1 to 4 and Comparative Examples 1, 3, and 4 was 0.5 g, and the catalyst sample was packed in the reaction tube. Meanwhile, the amount of the catalyst sample of each of Examples 5 to 6 and Comparative Example 2 was 0.25 g. To 0.25 g of the catalyst sample of each of Examples 5 to 6 and Comparative Example 2, 0.25 g of silica sand was further added, followed by mixing. Then, the mixture was packed in the reaction tube.

Next, a model exhaust gas of three harmful gases having the gas composition shown in Table 3 was supplied under a temperature condition of 600° C. at a flow rate of 10 L/minute for 6 minutes (pretreatment). After that, the temperature of each sample was cooled to 100° C. Then, while the model exhaust gas was being supplied at a flow rate of 10 L/minute, the sample was heated from 100° C. to 600° C. at a rate of temperature rise of 6° C./minute. The temperature (50% NOx removal temperature, ° C., referred to as “NOx_T50”) at which the NO removal ratio in the supplied model exhaust gas reached 50% was measured.

TABLE 3

| | CO₂ | O₂ | CO | NO | C₃H₆ | H₂ | H₂O | |
|---|---|---|---|---|---|---|---|---|
| | (% by volume) | (% by volume) | (% by volume) | (ppm) | (ppmC⁽*¹⁾) | (% by volume) | (% by volume) | N₂ |
| Model gas | 10.0 | 0.646 | 0.7 | 1200 | 1600 | 0.233 | 10.0 | Balance |

⁽*¹⁾ppmC (volume ratio in terms of carbon)

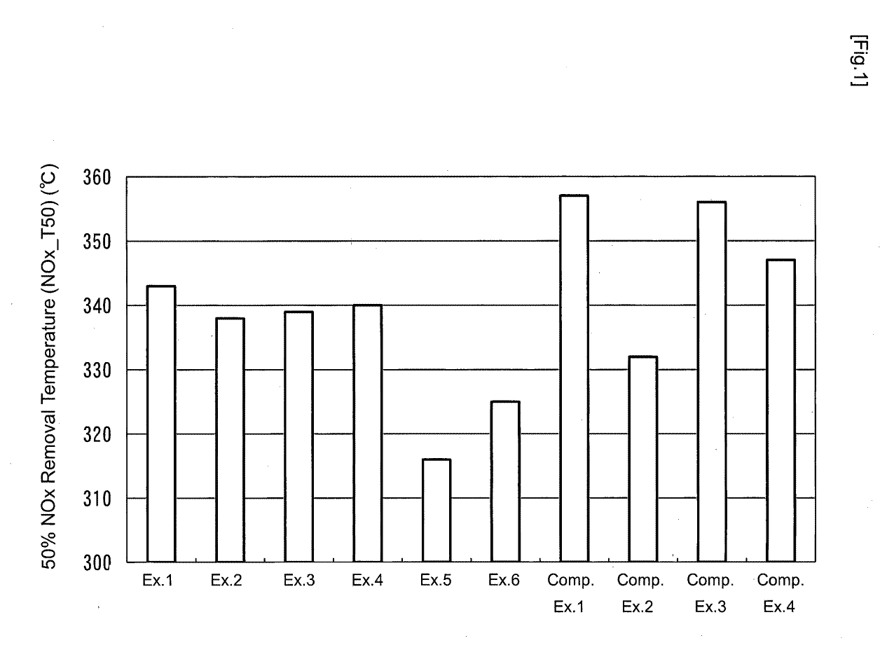

Table 1 shows the obtained results. In addition, FIG. 1 shows a graph showing the 50% NOx removal temperatures (NOx_T50) of the catalysts obtained in Examples 1 to 6 and Comparative Examples 1 to 2.

[Transient NOx Removal Activity Evaluation Test]

The transient NOx removal ratio of each of the catalysts obtained in Examples 1 to 6 and Comparative Examples 1 to 4 was measured by conducting a transient NOx removal activity evaluation test on the pellet catalyst sample subjected to the high-temperature endurance treatment by using a flow reactor and an exhaust gas analyzer as follows.

Specifically, first, the pellet catalyst sample subjected to the high-temperature endurance treatment was placed in a reaction tube (internal volume: 1.7 cm in diameter and 9.5 cm in length) of a normal pressure fixed bed flow type reactor. Note that the amount of the catalyst sample of each of Examples 1 to 4 and Comparative Examples 1, 3, and 4 was 0.5 g, and the catalyst sample was packed in the reaction tube. Meanwhile, the amount of the catalyst sample of each of Examples 5 and 6 and Comparative Example 2 was 0.25 g. To 0.25 g of the catalyst sample of each of Examples 5 and 6 and Comparative Example 2, 0.25 g of silica sand was further added, followed by mixing. Then, the mixture was packed in the reaction tube.

Next, under a temperature condition of 500° C., a lean model exhaust gas having the gas composition shown in Table 4 was passed at a flow rate of 10 L (liter)/minute for 180 seconds. Then, the gas composition was switched to that of a rich model exhaust gas having the gas composition shown in Table 4, and this rich model exhaust gas was passed at a flow rate of 10 L (liter)/minute for 180 seconds. This cycle was repeated several times. After that, the NOx removal ratio (transient NOx removal ratio, %) was measured 180 seconds after a switch of the gas composition from the lean one to the rich one.

TABLE 4

| | CO₂ | O₂ | CO | NO | C₃H₆ | H₂O | |
|---|---|---|---|---|---|---|---|
| | (% by volume) | (% by volume) | (% by volume) | (ppm) | (ppmC⁽*¹⁾) | (% by volume) | N₂ |
| Lean (L) | 10.0 | 0.8 | 0.65 | 1500 | 3000 | 5.0 | Balance |
| Rich (R) | 10.0 | 0.0 | 0.65 | 1500 | 3000 | 5.0 | Balance |

⁽*¹⁾ppmC (volume ratio in terms of carbon)

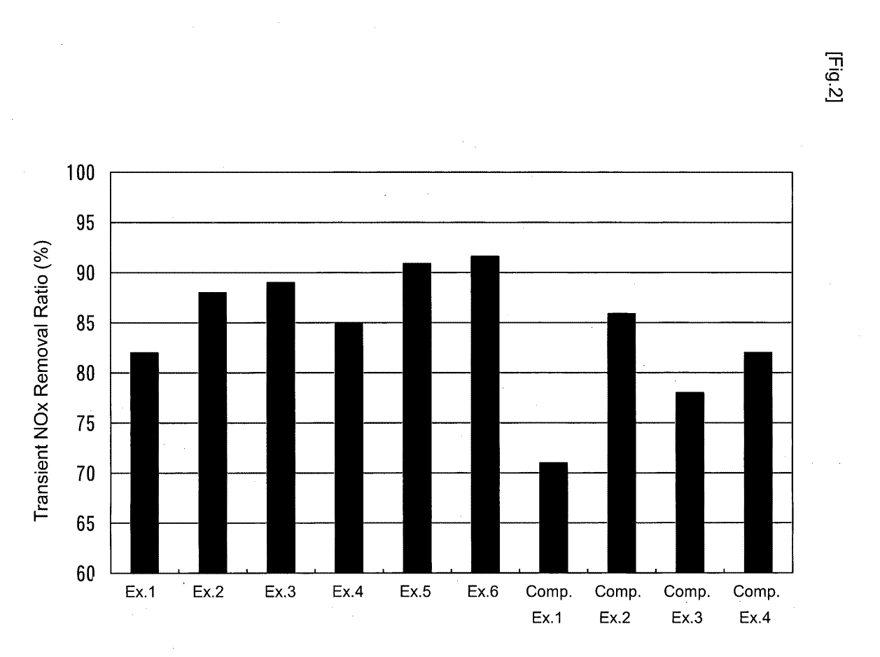

Table 1 shows the obtained results. In addition, FIG. 2 shows a graph showing the transient NOx removal ratios (%) of the catalysts obtained in Examples 1 to 6 and Comparative Examples 1 to 4.

[Test for Measuring OSC (Oxygen Storage/Release) Amount: OSC Activity Evaluation Test]

The OSC rate of each of the pellet catalyst samples obtained in Examples 1 to 6 and Comparative Examples 1 to 4 and subjected to the high-temperature endurance treatment was measured by performing an OSC activity evaluation test using a flow reactor and an analyzer as follows.

Specifically, first, the pellet catalyst sample subjected to the high-temperature endurance treatment was placed in a reaction tube (internal volume: 1.7 cm in diameter and 9.5 cm in length) of a normal pressure fixed bed flow type reactor. Note that the amount of the catalyst sample of each of Examples 1 to 4 and Comparative Examples 1, 3, and 4 was 0.5 g, and the catalyst sample was packed in the reaction tube. Meanwhile, the amount of the catalyst sample of each of Examples 5 and 6 and Comparative Example 2 was 0.25 g. To 0.25 g of the catalyst sample of each of Examples 5 and 6 and Comparative Example 2, 0.25 g of silica sand was further added, followed by mixing. Then, the mixture was packed in the reaction tube.

Next, a rich gas (CO (2% by volume)+N₂ (the balance)) and a lean gas (O₂ (1% by volume)+N₂ (the balance)) were passed alternately through the fixed bed flow type reactor under a temperature condition of 500° C., while being switched from one to the other every three minutes. After a switch to the rich gas, the amount of oxygen (O₂) generated in the rich gas atmosphere was measured, and the oxygen (O₂) generation rate, which was the amount of oxygen (O₂) generated in 5 seconds after the introduction of the rich gas, was determined as the oxygen storage/release (OSC) rate (μmol/g/sec or μmol-O₂/g/s). Note that the gas flow rate was 10 L/min, and an analyzer manufactured by BEST INSTRUMENTS CO., Ltd. under the trade name of “Bex5900Csp” was used.

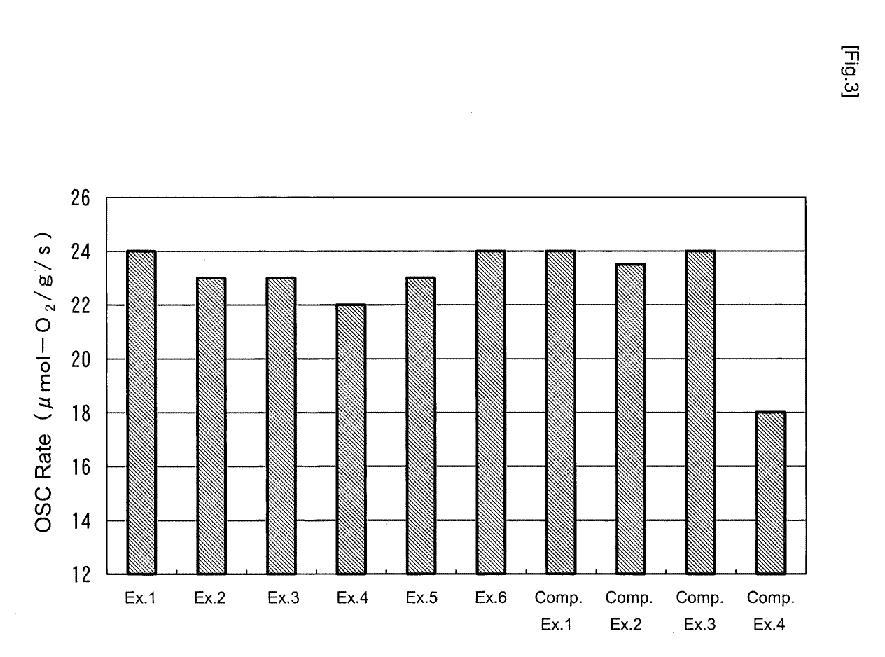

Table 1 shows the obtained results. In addition, FIG. 3 shows a graph showing the OSC rates (μmol-O₂/g/s) of the catalysts obtained in Examples 1 to 6 and Comparative Examples 1 to 4.

Table 5 shows the structures of the core-shell supports and catalysts for purification of exhaust gas obtained in Examples 1 to 6 and the catalyst supports for comparison and catalysts for comparison obtained in Comparative Examples 1 to 4.

TABLE 5

| | Structure of catalyst | | | | |
|---|---|---|---|---|---|
| | | | Amount of | | Amount of |
| | | | shell | | noble metal |
| | | | supported | Noble | supported |
| | Core | Shell | [% by mass] | metal | [% by mass] |
| Example 1 | CeO₂—ZrO₂—La₂O₃—Y₂O₃ | (La_{0.2}—Ce_{0.8})₂Zr₂O_{7.8} | 4.0 | Rh | 0.15 |
| Example 2 | CeO₂—ZrO₂—La₂O₃—Y₂O₃ | (La_{0.31}—Ce_{0.69})₂Zr₂O_{7.69} | 12.0 | Rh | 0.15 |
| Example 3 | CeO₂—ZrO₂—La₂O₃—Y₂O₃ | (La_{0.42}—Ce_{0.58})₂Zr₂O_{7.58} | 18.0 | Rh | 0.15 |
| Example 4 | CeO₂—ZrO₂—La₂O₃—Y₂O₃ | (La_{0.42}—Ce_{0.58})₂Zr₂O_{7.58} | 18.0 | Rh | 0.15 |
| Example 5 | Al₂O₃—CeO₂—ZrO₂—La₂O₃—Y₂O₃—Nd₂O₃ | (La_{0.57}—Ce_{0.43})₂Zr₂O_{7.43} | 12.0 | Rh | 0.15 |
| Example 6 | Al₂O₃—CeO₂—ZrO₂—La₂O₃—Y₂O₃—Nd₂O₃ | (La_{0.63}—Ce_{0.37})₂Zr₂O_{7.37} | 18.0 | Rh | 0.15 |
| Comp. Ex. 1 | CeO₂—ZrO₂—La₂O₃—Y₂O₃ | — | — | Rh | 0.15 |
| Comp. Ex. 2 | Al₂O₃—CeO₂—ZrO₂—La₂O₃—Y₂O₃—Nd₂O₃ | — | — | Rh | 0.15 |
| Comp. Ex. 3 | CeO₂—ZrO₂—La₂O₃—Y₂O₃ | (La_{0.12}—Ce_{0.88})₂Zr₂O_{7.88} | 2.0 | Rh | 0.15 |
| Comp. Ex. 4 | CeO₂—ZrO₂—La₂O₃—Y₂O₃ | (La_{0.52}—Ce_{0.48})₂Zr₂O_{7.48} | 25.0 | Rh | 0.15 |

As is apparent from a comparison of the results of Examples 1 to 6 with the results of Comparative Examples 1 to 4 shown in Table 1 and FIGS. 1 to 3, it was found that the core-shell support and catalyst for purification of exhaust gas of each of Examples 1 to 6 achieved both an excellent NOx removal ratio and an excellent OSC (oxygen storage/release capacity) property. Accordingly, it is conceivable that each of the catalysts of Examples 1 to 6 were excellent in both the performances of the NOx removal ratio and the OSC (oxygen storage/release capacity) property, because the catalyst comprised a core which comprised a ceria-zirconia based solid solution or an alumina-doped ceria-zirconia based solid solution, and a shell which comprised a rare earth-zirconia based composite oxide represented by the composition formula: (Re₁₋ₓCeₓ)₂Zr₂O₇₊ₓ (where Re represents a rare earth element, and x represents a number of 0.0 to 0.8) and with which the outside of the core was coated, the rare earth-zirconia based composite oxide comprised crystal particles having a pyrochlore structure, and the average crystallite diameter of the rare earth-zirconia based composite oxide was limited in the range from 3 to 9 nm.

### Examples 7 to 9 and Comparative Examples 5 to 7

<1. Materials Used>

[Material 1]

As alumina (Al₂O₃), a composite oxide containing 1% by mass of La₂O₃ and 99% by mass of Al₂O₃ was used (hereinafter, also referred to as “Material 1”).

[Material 2]

As an alumina-doped ceria-zirconia based solid solution (ACZL), a composite oxide containing 30% by mass of Al₂O₃, 20% by mass of CeO₂, 45% by mass of ZrO₂, and 5% by mass of La₂O₃ was used (hereinafter, also referred to as “Material 2”).

[Material 3]

As a core-shell support (LZ-ACZL) of the present invention, a core-shell support obtained as described below was used (hereinafter, also referred to as “Material 3”).

First, 10 g of a powder (average particle diameter: 8 μm, specific surface area: 70 m²/g) of Material 2 was prepared. Subsequently, a solution was prepared by dissolving 2.1×10³ mol of zirconyl oxynitrate (manufactured by Wako Pure Chemical Industries, Ltd.) and 2.1×10⁻³ mol of lanthanum nitrate hexahydrate (manufactured by Wako Pure Chemical Industries, Ltd.) in 100 ml of ion-exchanged water (solution preparation step) Next, 10 g of the powder was added to the prepared solution, followed by stirring for 15 minutes. Further, the mixture was heated with stirring to impregnate the powder with the solution (supporting by impregnation). Then, this impregnated powder was evaporated to dryness to obtain coagulation (evaporation to dryness). Subsequently, the obtained coagulationwas calcined in air under a temperature condition of 900° C. for 5 hours, and then ground into a powder by using a mortar for 30 minutes or more to obtain a core-shell powder (first coating step).

Subsequently, a core-shell support shown below was obtained by performing a single series of processes in which the prepared solution was supported on the obtained core-shell powder by impregnation, and then the impregnated powder was evaporated to dryness, followed by calcination and grinding in the same manner as in the above-described first coating step (second coating step)

Core: Al₂O₃—CeO₂—ZrO₂—La₂O₇
Shell (x=0 in the composition formula): La₂Zr₂O₇
Average crystallite diameter of shell: 6 nm
Amount of shell supported: 12.0% by mass.

[Material 4]

As an alumina-doped zirconia based solid solution (AZL), a composite oxide containing 30% by mass of Al₂O₃, 65% by mass of ZrO₂, and 5% by mass of La₂O₃ was used (hereinafter, also referred to as “Material 4”).

[Material 5]

As a material of a rhodium catalyst, an aqueous rhodium nitrate solution (manufactured by Cataler Corporation) having a noble metal content of 2.75% by mass was used (hereinafter, also referred to as “Material 5”).

[Material 6]

As a material of a palladium catalyst, an aqueous palladium nitrate solution (manufactured by Cataler Corporation) having a noble metal content of 8.8% by mass was used (hereinafter, also referred to as “Material 6”).

[Substrates]

As substrates, cordierite honeycomb substrates of 875 cc (600H/3-9R-08) (manufactured by DENSO CORPORATION) were used.

<2. Preparation of Catalysts>

### Comparative Example 5

Double-Layer Catalyst having Upper Layer (Rh(0.10)/ACZL(110)+Al₂O₃(28)) and Lower Layer (Pd(0.69)/ACZL(45)+Al₂O₃(40))

(Formation of Lower Layer)

First, by an impregnation method using Materials 2 and 6, a material in which palladium (Pd) was supported on the alumina-doped ceria-zirconia based solid solution (ACZL) was prepared (Pd/ACZL, hereinafter, also referred to as “Material 7”). Next, Material 7, Material 1, and an alumina-based binder (AS-200 manufactured by Nissan Chemical Industries, Ltd.) were suspended in distilled water with stirring to obtain a slurry. Subsequently, the obtained slurry was poured into the substrate. An unnecessary portion of the slurry was blown off with a blower. Through the above-described operations, the surfaces of inner walls of the substrate were coated with the materials. Here, the preparation was conducted under such conditions that the resultant substrate coated with the lower layer contained 0.69 g/L of palladium, 40 g/L of Material 1, and in 45 g/L of Material 2, per liter of the capacity of the substrate. After that, the substrate coated with the slurry was allowed to stand in a dryer set at 120° C. for 2 hours to allow evaporation of water in the slurry. Further, the substrate was allowed to stand in an electric furnace set at 500° C. for 2 hours to obtain a substrate having a palladium-containing catalyst layer.

(Formation of Upper Layer)

Next, by an impregnation method using Materials 2 and 5, a material in which rhodium (Rh) was supported on the alumina-doped ceria-zirconia based solid solution (ACZL) was prepared (Rh/ACZL, hereinafter, also referred to as “Material 8”). Next, Material 8, Material 1, and the alumina-based binder were suspended in distilled water with stirring to obtain a slurry. Subsequently, the obtained slurry was poured into the substrate having the palladium-containing catalyst layer. An unnecessary portion of the slurry was blown off with a blower. Through the above-described operations, surfaces of inner walls of the substrate were coated with the materials. Here, the preparation was conducted under such conditions that the resultant substrate coated with the upper layer contained 0.10 g/L of rhodium, 28 g/L of Material 1, and 110 g/L of Material 2, per liter of the capacity of the substrate. After that, the substrate coated with the slurry was allowed to stand in a dryer set at 120° C. for 2 hours to allow evaporation of water in the slurry. Further, the substrate was allowed to stand in an electric furnace set at 500° C. for 2 hours. Thus, a double-layer catalyst was obtained which had the rhodium-containing catalyst layer as the upper layer and the palladium-containing catalyst layer as the lower layer.

### Comparative Example 6

Double-Layer Catalyst having Upper Layer (Rh(0.10)/AZL(55)+ACZL(55)+Al₂O₃(28)) and Lower Layer (Pd(0.69)/ACZL(45)+Al₂O₃(40)) First, by an impregnation method using Materials 4 and 5, a material in which rhodium (Rh) was supported on alumina-doped zirconia based solid solution (AZL) was prepared (Rh/AZL, hereinafter, also referred to as “Material 9”). Next, a double-layer catalyst having a rhodium-containing catalyst layer as the upper layer and a palladium-containing catalyst layer as the lower layer was obtained by the same procedure as that in Comparative Example 5, except that a slurry containing Material 9, Material 2, Material 1, and the alumina-based binder was used in the step of forming the upper layer. Here, the preparation was conducted under such conditions that the resultant substrate coated with the upper layer contained 0.10 g/L of rhodium, 28 g/L of Material 1, 55 g/L of Material 2, and 55 g/L of Material 4, per liter of the capacity of the substrate.

### Comparative Example 7

Double-Layer Catalyst having Upper Layer (Rh(0.05)/AZL(55)+Rh(0.05)/ACZL(55)+Al₂O₃(28)) and Lower Layer (Pd(0.69)/ACZL(45)+Al₂O₃(40)) A double-layer catalyst having a rhodium-containing catalyst layer as the upper layer and a palladium-containing catalyst layer as the lower layer was obtained by the same procedure as that in Comparative Example 5, except that a slurry containing Material 9, Material 8, Material 1, and the alumina-based binder was used in the step of forming the upper layer. Here, the preparation was conducted under such conditions that the resultant substrate coated with the upper layer contained 0.10 g/L of rhodium, 28 g/L of Material 1, 55 g/L of Material 2, and 55 g/L of Material 4, per liter of the capacity of the substrate.

### Example 7

Double-Layer Catalyst having Upper Layer (Rh(0.10)/LZ-ACZL(110)+Al₂O₃(28)) and Lower Layer (Pd(0.69)/ACZL(45)+Al₂O₃(40))

First, by an impregnation method using Materials 3 and 5, a material in which rhodium (Rh) was supported on the core-shell support of the present invention (LZ-ACZL) was prepared (Rh/LZ-ACZL, hereinafter, also referred to as “Material 10”). Next, a double-layer catalyst having a rhodium-containing catalyst layer as the upper layer and a palladium-containing catalyst layer as the lower layer was obtained by the same procedure as that in Comparative Example 5, except that a slurry containing Material 10, Material 1, and the alumina-based binder was used in the step of forming the upper layer. Here, the preparation was conducted under such conditions that the resultant substrate coated with the upper layer contained 0.10 g/L of rhodium, 28 g/L of Material 1, and 110 g/L of Material 3, per liter of the capacity of the substrate.

### Example 8

Double-Layer Catalyst having Upper Layer (Rh(0.10)/AZL(55)+LZ-ACZL(55)+Al₂O₃(28)) and Lower Layer (Pd(0.69)/ACZL(45)+Al₂O₃(40)) A double-layer catalyst having a rhodium-containing catalyst layer as the upper layer and a palladium-containing catalyst layer as the lower layer was obtained by the same procedure as that in Comparative Example 5, except that a slurry containing Material 9, Material 3, Material 1, and the alumina-based binder was used in the step of forming the upper layer. Here, the preparation was conducted under such conditions that the resultant substrate coated with the upper layer contained 0.10 g/L of rhodium, 28 g/L of Material 1, 55 g/L of Material 3, and 55 g/L of Material 4, per liter of the capacity of the substrate.

### Example 9

Double-Layer Catalyst having Upper Layer (Rh(0.05)/AZL(55)+Rh(0.05)/LZ-ACZL(55)+Al₂O₃(28)) and Lower Layer (Pd(0.69)/ACZL(45)+Al₂O₃(40))

A double-layer catalyst having a rhodium-containing catalyst layer as the upper layer and a palladium-containing catalyst layer as the lower layer was obtained by the same procedure as that in Comparative Example 5, except that a slurry containing Material 9, Material 10, Material 1, and the alumina-based binder was used in the step of forming the upper layer. Here, the preparation was conducted under such conditions that the resultant substrate coated with the upper layer contained 0.10 g/L of rhodium, 28 g/L of Material 1, 55 g/L of Material 3, and 55 g/L of Material 4, per liter of the capacity of the substrate.

<3. Evaluation Methods of Catalysts>

[Durability Treatment]

Using a gasoline engine (1UR-FE, manufactured by Toyota Motor Corporation), an accelerated deterioration treatment was performed on the catalysts of Examples 7 to 9 and Comparative Examples 5 to 7 under conditions of 1000° C. (catalyst bed temperature) and 25 hours. At this time, by adjusting a throttle opening angle and an engine load, the treatment was repeatedly performed in a constant circle: a rich condition, a stoichiometric condition, and a lean condition. In this manner, the composition of exhaust gas was changed, and the deterioration of the catalysts was accelerated.

[OSC Evaluation Test]

Using a gasoline engine (2AZ-FE, manufactured by Toyota Motor Corporation), oxygen storage characteristics of the catalysts of Examples 7 to 9 and Comparative Examples 5 to 7 were evaluated (after the accelerated deterioration treatment). An air-fuel ratio (A/F) was feedback-controlled aiming at an A/F of 14.1 or 15.1. The excess or deficiency of oxygen was calculated according to the following expression from a difference (AA/F) between the theoretical air-fuel ratio and an A/F sensor output at the stoichiometric point. The maximum oxygen storage was evaluated as OSC.

OSC [g]=0.23×λA/F×Fuel Injection Amount.

[Steady-State NOx Removal Performance Evaluation Test]

Using a gasoline engine (2AZ-FE, manufactured by Toyota Motor Corporation), the steady-state NOx removal performance of the catalysts of Examples 7 to 9 and Comparative Examples 5 to 7 was evaluated (after the accelerated deterioration treatment). An air-fuel ratio (A/F) was feedback-controlled aiming at an A/F of 14.1, and the NOx emission in the exhaust gas having passed through each catalyst was determined under a condition of 600° C.

<4. Evaluation Results of Catalysts>

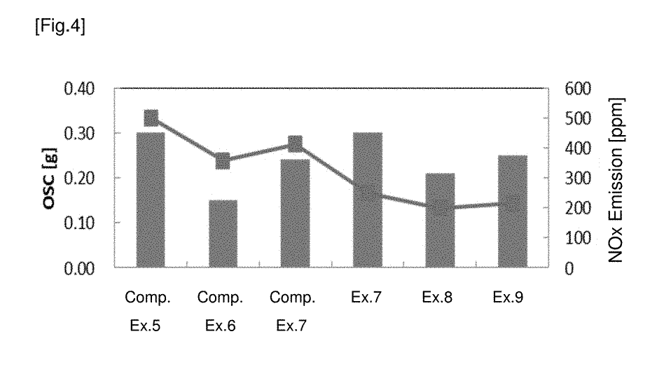

The maximum oxygen storage (OSC) and the NOx emission of each of the catalysts of Examples 7 to 9 and Comparative Examples 5 to 7 (after the accelerated deterioration treatment) were evaluated by the above-described procedures. Table 6 and FIG. 4 show the results. Note that, in FIG. 4, the bar graph shows the maximum oxygen storage (OSC), and the line graph shows the NOx emission.

TABLE 6

| | Maximum oxygen storage | |
|---|---|---|
| | (OSC) | NOx emission |
| | [g] | [ppm] |
| Comp. Ex. 5 | 0.30 | 500 |
| Comp. Ex. 6 | 0.15 | 358 |
| Comp. Ex. 7 | 0.24 | 412 |
| Ex. 7 | 0.30 | 250 |
| Ex. 8 | 0.21 | 200 |
| Ex. 9 | 0.25 | 215 |

As shown in Table 6 and FIG. 4, since the noble metal was directly supported on the OSC material in the coat layer (upper layer) of the catalyst of Comparative Example 5, the catalyst of Comparative Example 5 achieved high OSC performance, but the NOx emission was very large. Meanwhile, in the catalyst of Comparative Example 6, the noble metal was supported on the other material and was coexistent with the OSC material in the coat layer (upper layer). The catalyst of Comparative Example 6 was improved in terms of NOx emission, but the OSC performance was deteriorated very much. In addition, in the catalyst of Comparative Example 7, a half of the noble metal was directly supported on the OSC material, and the other half of the noble metal was supported on the other material. The performances of the catalyst of Comparative Example 7 were rated between those of the catalyst of Comparative Example 5 and those of the catalyst of Comparative Example 6, and the two performances were not improved.

In the catalysts of Examples 7 to 9 each using the core-shell support of the present invention, LZ-ACZL, which was a surface-modified OSC material, was used. It was found that, for this reason, the catalyst of Examples 7 was improved in terms of NOx removal performance and also achieved a high level of OSC performance, even though the noble metal was directly supported on the core-shell support of the present invention in the coat layer (upper layer). In addition, it was found that the catalyst of Example 8 was improved in terms of NOx removal performance and also achieved a high level of OSC performance, even though the noble metal was supported on the other material and was coexistent with the core-shell support of the present invention in the coat layer (upper layer). Moreover, it was found that the catalyst of Example 9 was improved in terms of OSC performance without any deterioration in NOx removal performance, even though a half of the noble metal was directly supported on the core-shell support of the present invention and the other half of the noble metal was supported on the other material.

### INDUSTRIAL APPLICABILITY

As described above, according to the present invention, it is possible to provide a core-shell support which enables both sufficiently good oxygen storage/release capacity (OSC) and sufficiently good NOx removal activity to be exhibited, a method for producing the core-shell support, a catalyst for purification of exhaust gas using the core-shell support, a method for producing the catalyst, and a method for purification of exhaust gas using the catalyst for purification of exhaust gas. The core-shell support of the present invention and the catalyst for purification of exhaust gas using the core-shell support of the present invention offer both sufficiently good oxygen storage/release capacity (OSC) and sufficiently good NOx removal activity as described above, and hence enable both sufficiently good oxygen storage/release capacity (OSC) and sufficiently good NOx removal activity to be exhibited. By bringing, for example, an exhaust gas from an internal combustion engine into contact with such a catalyst for purification of exhaust gas of the present invention, the catalyst for purification of exhaust gas of the present invention can sufficiently exhibit both sufficiently high oxygen storage/release capacity (OSC) and sufficiently high NOx removal activity, and can sufficiently remove harmful gases such as NOx contained in the exhaust gas.

Accordingly, the core-shell support, the method for producing the core-shell support, the catalyst for purification of exhaust gas using the core-shell support, the method for producing the catalyst, and the method for purification of exhaust gas using the catalyst for purification of exhaust gas of the present invention can be employed suitably as a core-shell support for removing harmful components such as harmful gases (hydrocarbons (HC), carbon monoxide (CO), and nitrogen oxides (NOx)) contained in an exhaust gas emitted from, for example, an internal combustion engine in an automobile or the like, a method for producing the core-shell support, a catalyst for purification of exhaust gas using the core-shell support, a method for producing the catalyst, a method for purification of exhaust gas using the catalyst for purification of exhaust gas, and the like.

1.-13. (canceled)

14. A core-shell support, comprising:
a core which comprises at least one oxygen storage/release material selected from alumina-doped ceria-zirconia based solid solutions; and
a shell which comprises a rare earth-zirconia based composite oxide represented by a composition formula: (Re₁₋ₓCeₓ)₂Zr₂O₇₊ₓ (where Re represents a rare earth element being at least one element selected from the group consisting of La, Nd, Pr, Pm, Sm, Eu, Gd, Tb, Dy, Ho, Er, Tm, Yb, Lu, Sc and Y, and x represents a number of 0.0 to 0.8) and with which an outside of the core is coated,
the rare earth-zirconia based composite oxide comprising crystal particles having a pyrochlore structure, and
the rare earth-zirconia based composite oxide having an average crystallite diameter of 3 to 9 nm, wherein
an amount of the rare earth-zirconia based composite oxide constituting the shell is 4 to 24 parts by mass relative to 100 parts by mass of the oxygen storage/release material constituting the core.

15. The core-shell support according to claim 14, wherein
x in the composition formula is a number of 0.5 to 0.7.

16. The core-shell support according to claim 14, wherein
Re in the composition formula is at least one element selected from the group consisting of La, Nd, Pr, and Y.

17. A catalyst for purification of exhaust gas, comprising:
the core-shell support according to claim 14; and
a noble metal supported on the core-shell support.

18. The catalyst for purification of exhaust gas according to claim 17, wherein
the noble metal is Rh.

19. A catalyst for purification of exhaust gas, comprising:
a substrate; and
a catalyst layer disposed on the substrate, wherein
the catalyst layer comprises the core-shell support according to claim 14, alumina, and a noble metal.

20. The catalyst for purification of exhaust gas according to claim 19, wherein
the catalyst layer, which comprises the core-shell support, the alumina and the noble metal, is a rhodium-containing catalyst layer containing Rh as the noble metal, and
a palladium-containing catalyst layer containing an alumina-doped ceria-zirconia based solid solution, alumina, and Pd is disposed between the substrate and the rhodium-containing catalyst layer.

21. A method for producing the core-shell support according to claim 14, comprising:
a solution preparation step of preparing a solution containing a rare earth element salt and a zirconium salt;
a first coating step of bringing the prepared solution into contact with a powder of at least one oxygen storage/release material selected from alumina-doped ceria-zirconia based solid solutions to obtain a core-shell powder supporting the prepared solution in an amount which gives, after calcination to an oxide, 1 to 8 parts by mass of the rare earth-zirconia based composite oxide constituting a part of the shell relative to 100 parts by mass of the oxygen storage/release material constituting the core, followed by calcination at a temperature in a range from 600 to 1100° C. and then by grinding; and
a second coating step of bringing the prepared solution into contact with the obtained core-shell powder to obtain the core-shell powder additionally supporting the prepared solution in an amount which gives, after calcination to an oxide, 1 to 8 parts by mass of the rare earth-zirconia based composite oxide constituting a part of the shell relative to 100 parts by mass of the oxygen storage/release material constituting the core, followed by calcination at a temperature in a range from 600 to 1100° C. and then by grinding,
the core-shell support being obtained by performing the second coating step until an amount of the rare earth-zirconia based composite oxide constituting the shell after the calcination to the oxide reaches 4 to 24 parts by mass relative to 100 parts by mass of the oxygen storage/release material constituting the core.

22. A method for producing the catalyst for purification of exhaust gas according to claim 17, comprising:
a solution preparation step of preparing a solution containing a rare earth element salt and a zirconium salt;
a first coating step of bringing the prepared solution into contact with a powder of at least one oxygen storage/release material selected from alumina-doped ceria-zirconia based solid solutions to obtain a core-shell powder supporting the prepared solution in an amount which gives, after calcination to an oxide, 1 to 8 parts by mass of the rare earth-zirconia based composite oxide constituting a part of the shell relative to 100 parts by mass of the oxygen storage/release material constituting the core, followed by calcination at a temperature in a range from 600 to 1100° C. and then by grinding; and
a second coating step of bringing the prepared solution into contact with the obtained core-shell powder to obtain the core-shell powder additionally supporting the prepared solution in an amount which gives, after calcination to an oxide, 1 to 8 parts by mass of the rare earth-zirconia based composite oxide constituting a part of the shell relative to 100 parts by mass of the oxygen storage/release material constituting the core, followed by calcination at a temperature in a range from 600 to 1100° C. and then by grinding,
the core-shell support being obtained by performing the second coating step until an amount of the rare earth-zirconia based composite oxide constituting the shell after the calcination to the oxide reaches 4 to 24 parts by mass relative to 100 parts by mass of the oxygen storage/release material constituting the core, and then
the catalyst for purification of exhaust gas being obtained by bringing a noble metal salt solution into contact with the core-shell support.

23. A method for purification of exhaust gas, comprising:
purifying an exhaust gas emitted from an internal combustion engine by bringing the exhaust gas into contact with the catalyst for purification of exhaust gas according to claim 17.

24. A method for purification of exhaust gas, comprising:
purifying an exhaust gas emitted from an internal combustion engine by bringing the exhaust gas into contact with the catalyst for purification of exhaust gas according to claim 19.
